(19) United States
(12) Patent Application Publication
(10) Pub. No.: US 2024/0072365 A1
(43) Pub. Date: Feb. 29, 2024

(54) BATTERY MODULE

(71) Applicant: TOYOTA JIDOSHA KABUSHIKI KAISHA, Aichi-ken (JP)

(72) Inventor: Kenichi KOHASHI, Sunto-gun (JP)

(21) Appl. No.: 18/452,570

(22) Filed: Aug. 21, 2023

(30) Foreign Application Priority Data
Aug. 29, 2022 (JP) 2022-136326

(51) Int. Cl. H01M 50/291; H01M 10/04; H01M 50/209

(52) U.S. Cl. CPC H01M 50/291; H01M 10/0468; H01M 50/209

(57) ABSTRACT

A battery module includes: a battery stack including a cell stack, and a pair of end plates; and a case including an opening and an accommodation space. Further, each end plate includes, as an outer end surface, an end plate-side end surface, the case includes, a case-side end surface inclined, the end plate includes a recess formed so as to surround a part of the end plate-side end surface, the case includes a hole formed at a position facing a region in the stacking direction, the region being surrounded by the recess of the end plate, and when the battery stack is accommodated in the case, a contact surface of the end plate-side end surface is pressed inward so that the region surrounded by the recess relatively protrudes outward in the stacking direction from the contact surface and enters an inside of the hole.

### CROSS-REFERENCE TO RELATED APPLICATION(S)

The present application claims priority to and incorporates by reference the entire contents of Japanese Patent Application No. 2022-136326 filed in Japan on Aug. 29, 2022.

### BACKGROUND

The present disclosure relates to a battery module.

Japanese Laid-open Patent Publication No. 2018-032519 discloses a battery module in which a battery stack including a cell stack and an end plate is accommodated in a case. In this battery module, a restraint load of the cell stack is generated by a contact structure between the end plate and the case. Specifically, an end surface of the end plate and an end surface of the case facing each other in a stacking direction are inclined surfaces, and the inclined surfaces come into contact with each other in a state where the battery stack is compressed in the stacking direction, whereby a restraint load is applied from the case to the cell stack.

### SUMMARY

There is a need for providing a battery module capable of suppressing positional displacement of the battery stack without impairing insertability of the battery stack into the case.

According to an embodiment, a battery module includes: a battery stack including a cell stack in which a plurality of battery cells are stacked in a thickness direction, and a pair of end plates disposed at both ends of the cell stack in a stacking direction; and a case including an opening at an upper portion of the case, and an accommodation space in which the battery stack is accommodated. Further, each of the end plates includes, as an outer end surface in the stacking direction, an end plate-side end surface inclined such that a dimension of the battery stack in the stacking direction decreases toward a lower end of the end plate, the case includes, as an inner end surface in the stacking direction, a case-side end surface inclined such that a dimension of the accommodation space in the stacking direction decreases toward a lower end of the case, the end plate-side end surface and the case-side end surface are brought into contact with each other to apply a restraint load in the stacking direction to the cell stack, the end plate includes a recess formed so as to surround a part of the end plate-side end surface, the case includes a hole formed at a position facing a region in the stacking direction, the region being surrounded by the recess of the end plate, and in a state where the battery stack is accommodated in the case, a contact surface of the end plate-side end surface that is in contact with the case-side end surface is pressed inward in the stacking direction from the case-side end surface so that the region surrounded by the recess relatively protrudes outward in the stacking direction from the contact surface and enters an inside of the hole.

### BRIEF DESCRIPTION OF THE DRAWINGS

FIG. 1 is a diagram schematically illustrating a battery module according to an embodiment;

FIG. 2 is a diagram illustrating a state before the battery stack is assembled to a case;

FIG. 3 is a diagram illustrating an outer end surface of an end plate in a stacking direction;

FIG. 4 is a cross-sectional view illustrating a cross section taken along line A-A in FIG. 3;

FIG. 5 is a diagram for explaining an insertion step;

FIG. 6 is a diagram illustrating an unloaded state;

FIG. 7 is a diagram illustrating a load application state;

FIG. 8 is a diagram schematically illustrating a structure of a comparative example;

FIG. 9 is a diagram schematically illustrating a battery module according to a modified example;

FIG. 10 is a diagram for explaining a structure of a case;

FIG. 11 is a diagram for explaining an end plate of the modified example;

FIG. 12 is a diagram schematically illustrating a structure of the end plate of the modified example;

FIG. 13 is a diagram for explaining a relationship with a machine-side tool;

FIG. 14 is a diagram for explaining an end plate in a further modified example;

FIG. 15 is a diagram schematically illustrating a structure of the end plate in the further modified example; and

FIG. 16 is a cross-sectional view illustrating a cross section taken along line H-H in FIG. 15.

### DETAILED DESCRIPTION

In the related art, in the configuration described, for example, in Japanese Laid-open Patent Publication No. 2018-032519, sawtooth-shaped irregularities are formed on the end surface of the case and the end surface of the end plate in order to suppress upward movement of the battery stack along the end surface of the case as positional displacement of the battery stack. However, since it is not easy to produce the saw-tooth structure, forming the saw-tooth irregularities leads to an increase in cost. Furthermore, when the battery stack is inserted into the case, since the battery stack is inserted while the end surfaces are rubbed with each other, there is a possibility that the restraint load varies due to variation in frictional force due to the saw-tooth irregularities, and a part of the sawtooth shape falls off due to wear and becomes a foreign substance.

Hereinafter, a battery module according to an embodiment of the present disclosure will be specifically described with reference to the drawings. Note that the present disclosure is not limited to the embodiments described below.

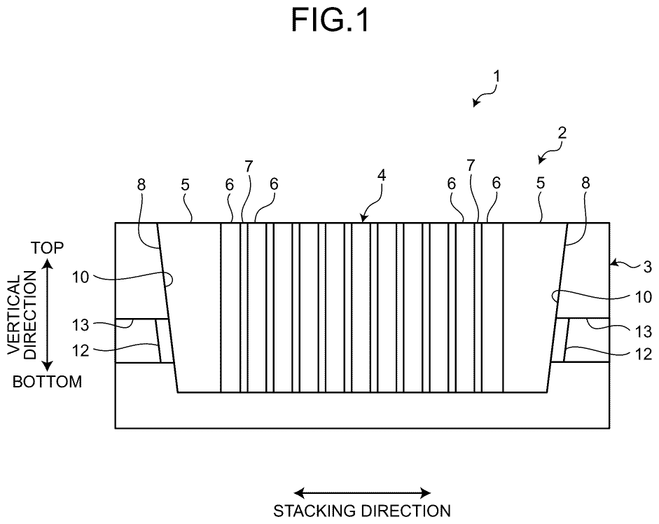

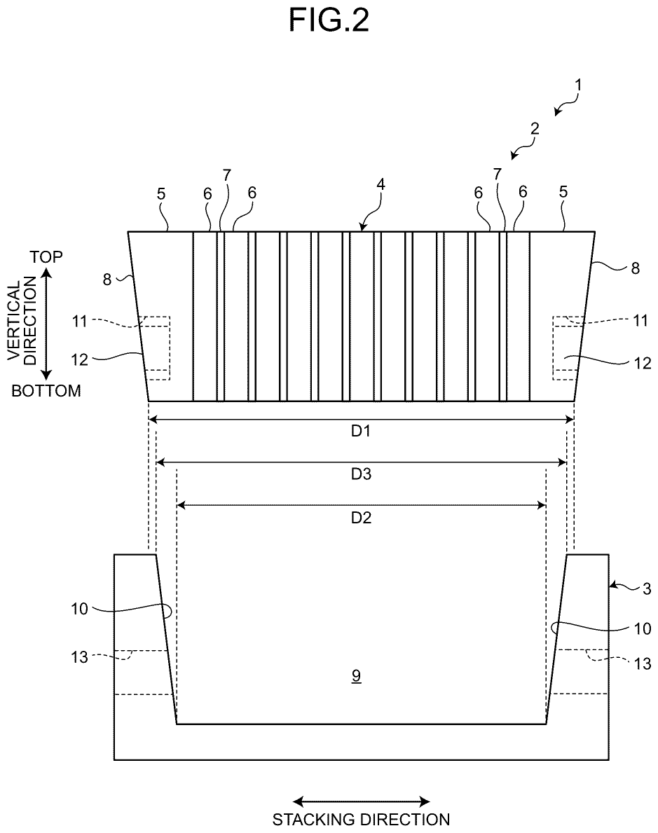

FIG. 1 is a diagram schematically illustrating a battery module according to an embodiment. FIG. 2 is a diagram illustrating a state before the battery stack is assembled to a case.

A battery module 1 includes a battery stack 2 and a case 3 that accommodates the battery stack 2.

The battery stack 2 includes a cell stack 4 and a pair of end plates 5 disposed on both sides of the cell stack 4 in a stacking direction. The battery stack 2 is a stack including the cell stack 4 and the end plates 5. The battery stack 2 is used in a state where a compressive load is applied in the stacking direction. Note that the stacking direction of the cell stack 4 is simply referred to as a stacking direction, and a direction parallel to the stacking direction is referred to as a stacking direction when a configuration other than the cell stack 4 is described.

The cell stack 4 includes battery cells 6 and separators 7. The cell stack 4 is a stack including the battery cells 6 and the separators 7. The cell stack 4 has a structure in which the plurality of battery cells 6 and the plurality of separators 7 are alternately stacked in a thickness direction. The plate-shaped separator 7 serving as an insulating layer is disposed between the battery cell 6 and the battery cell 6.

The battery cell 6 is a chargeable and dischargeable secondary battery. For example, the battery cell 6 is constituted by a lithium ion secondary battery or a sodium ion secondary battery. The battery cell 6 includes a battery cell whose exterior is laminated and packaged in addition to an aluminum can. For example, the battery cell 6 is a rectangular battery in which an electrode body is accommodated in a flat rectangular parallelepiped cell case, and a positive electrode terminal and a negative electrode terminal protrude from an upper end surface of the battery cell 6. Note that out of outer surfaces of the battery cell 6, a surface facing a side of the stacking direction is referred to as a surface of the battery cell 6.

The separator 7 is a plate-like member made of resin, and is made of an insulating material. The separator 7 made of resin can expand and contract in the stacking direction. That is, since the battery stack 2 is a stack including the separator 7 made of resin, the battery stack 2 is an elastic body having a spring constant in the stacking direction.

The pair of end plates 5 is disposed on both sides in the stacking direction of the cell stack 4 including the battery cells 6 and the separators 7. The pair of end plates 5 is configured to sandwich the cell stack 4 from both sides in the stacking direction, and apply a restraint load, which is a compressive force in the stacking direction, to the battery cells 6.

Each of the end plates 5 is a plate-like member made of metal such as aluminum or resin. The end plate 5 has, as an end surface of the battery stack 2, an end plate-side end surface 8 formed to face outward in the stacking direction. In the end plate 5, a surface opposite to the end plate-side end surface 8 is formed in a plane orthogonal to the stacking direction (vertical surface extending along a vertical direction).

The end plate-side end surface 8 is an end surface on an outer side in the stacking direction, and faces an inner end surface of the case 3 in the stacking direction. The end plate-side end surface 8 is formed as an inclined surface that is inclined such that a dimension of the battery stack 2 in the stacking direction decreases toward a lower end of the end plate 5. As a result, the battery stack 2 has a structure in which the dimension in the stacking direction decreases toward a lower end of the battery stack 2. This structure is a structure for applying an appropriate restraint load from the case 3 to the cell stack 4 in a state where the battery stack 2 is accommodated in the accommodation space 9 of the case 3.

The case 3 is a structural member for applying a compressive load (restraint load) to the battery stack 2. The case 3 is a box-shaped member made of a material mainly made of metal such as aluminum.

As illustrated in FIG. 2, the case 3 has the accommodation space 9 for accommodating the battery stack 2. The accommodation space 9 is a space in which an upper portion is opened, and is a space into which the battery stack 2 can be inserted from the upper opening. Furthermore, the case 3 has, as an inner surface of the case 3, a case-side end surface 10 formed to face the inside in the stacking direction.

The case-side end surface 10 is an inner end surface of the case 3, and faces the end plate-side end surface 8 in the stacking direction. The case-side end surface 10 is formed as an inclined surface that is inclined such that a dimension of the accommodation space 9 in the stacking direction decreases toward a lower end of the case 3. That is, the case-side end surface 10 forms an end surface on an outer side in the stacking direction of the accommodation space 9, and is inclined so that a length in the stacking direction of the accommodation space 9 decreases. An inclination angle of the case-side end surface 10 is set to be the same angle as an inclination angle of the end plate-side end surface 8.

Furthermore, the battery module 1 has a structure (hereinafter, referred to as a catch structure) in which the battery stack 2 is mechanically caught by the case 3 as a structure for regulating the upward movement of the battery stack 2 along the case-side end surface 10 in a state where the battery stack 2 is accommodated in the accommodation space 9. The catch structure is formed by the end plate 5 and the case 3, and includes a groove 11 provided in the end plate 5 and a hole 13 provided in the case 3.

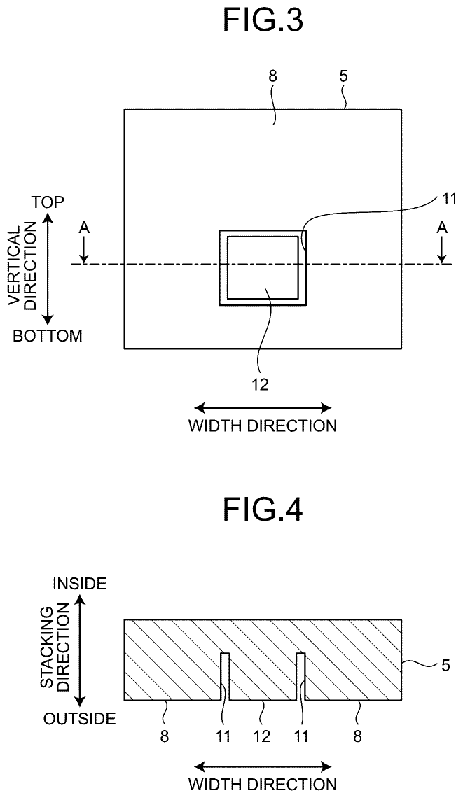

As illustrated in FIG. 3, the end plate 5 has the groove 11 formed so as to surround a part of the end plate-side end surface 8. The end plate-side end surface 8 includes a region 12 surrounded by the groove 11 and a region not surrounded by the groove 11. The region 12 surrounded by the groove 11 in the end plate-side end surface 8 includes an end face inclined at the same inclination angle as the end plate-side end surface 8. The region of the end plate-side end surface 8 not surrounded by the groove 11 is a surface facing the case-side end surface 10 in the stacking direction, and is a contact surface in contact with the case-side end surface 10.

The groove 11 is formed so as to surround the region 12 in a quadrangular shape at a center position in the width direction and a position lower than a center position in the vertical direction in the end plate-side end surface 8. The groove 11 includes an upper groove extending linearly along the width direction on a relatively upper side, a lower groove extending linearly along the width direction on a relatively lower side, and both width-direction end grooves extending linearly along the vertical direction so as to connect both width-direction end portions of the upper groove and the lower groove.

Furthermore, as illustrated in FIG. 4, the groove 11 is formed in a shape depressed inward in the stacking direction from the end plate-side end surface 8. A depth of the groove 11 is formed to be deep to some extent in order to relatively increase an amount of the region 12 protruding outward in the stacking direction when the contact surface of the end plate-side end surface 8 is pressed. For example, the depth of the groove 11 can be set to a depth more than or equal to a half of a dimension in the stacking direction of the end plate 5 forming an opening end of the groove 11. Furthermore, bottoms of the grooves 11 are formed at the same position in the stacking direction. That is, since the end plate-side end surface 8 is an inclined surface inclined with respect to the vertical direction, when the bottoms of the grooves 11 are formed at the same position in the stacking direction, the grooves 11 are not entirely formed at the same depth. In this case, the upper groove of the groove 11 is formed deeper than the lower groove of the groove 11. Moreover, the depth of the both width-direction end grooves of the groove 11 changes along the vertical direction.

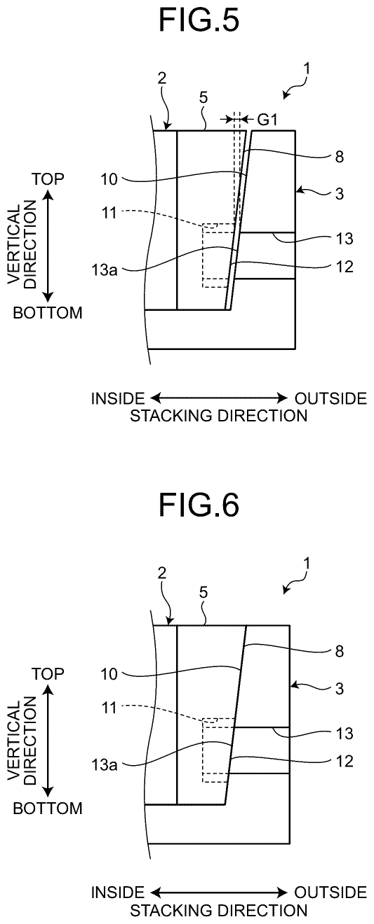

As illustrated in FIG. 5, the case 3 has the hole 13 provided at a position corresponding to the region 12 surrounded by the groove 11. The hole 13 is a hole formed in the case-side end surface 10, and is formed at a position facing the region 12 of the end plate 5 in the stacking direction. The hole 13 has an opening 13a facing the region 12 of the end plate 5 in the stacking direction. The opening 13a is formed in a quadrangular shape corresponding to the shape of the region 12 illustrated in FIG. 3. The hole 13 is formed of, for example, a through hole through which the case 3 penetrates in the stacking direction.

Furthermore, in a state before the battery stack 2 is assembled to the case 3, as illustrated in FIG. 2, a length D1 in the stacking direction of a lower end of the battery stack 2 in an unloaded state is longer than a length D2 in the stacking direction of a lower end of the accommodation space 9 (D1>D2). Moreover, the length D1 in the stacking direction of the lower end of the battery stack 2 in the unloaded state is longer than a length D3 in the stacking direction of an upper end of the accommodation space 9 (D1>D3). The length D3 in the stacking direction of the upper end of the accommodation space 9 is longer than the length D2 in the stacking direction of the lower end of the accommodation space 9. Therefore, in the battery module 1, after the battery stack 2 including the cell stack 4 and the pair of end plates 5 is formed, the battery stack 2 is compressed in the stacking direction and inserted into the case 3.

When the battery stack 2 is assembled to the case 3 from the state illustrated in FIG. 2, the battery stack 2 is inserted into the accommodation space 9 from the upper portion of the accommodation space 9.

Here, a process performed when the battery stack 2 is assembled to the case 3 will be described. First, in an insertion step, as illustrated in FIG. 5, the battery stack 2 is inserted into the case 3 in a state of being compressed in the stacking direction. In this inserted state, the end plate-side end surface 8 is not in contact with the case-side end surface 10. For example, the battery stack 2 is compressed in the stacking direction using an insertion tool or the like. The battery stack 2 in a compressed state by the tool or the like is inserted from the upper portion of the accommodation space 9. In a state where the lower end of the battery stack 2 is in contact with a bottom surface of the case 3 (insertion step), a compressive force of the tool acts on the battery stack 2, so that a gap G1 is provided between the end plate-side end surface 8 and the case-side end surface 10.

In this insertion step, the insertion tool can apply a compressive force in the stacking direction to the battery stack 2 without pressing the end plate-side end surface 8. Therefore, in the insertion step, the end plate 5 is maintained in the unloaded state.

The unloaded state represents a state of the end plate 5, and refers to a state in which no compressive force in the stacking direction acts on the end plate-side end surface 8. Specifically, as illustrated in FIG. 2, in the battery stack 2 in an uncompressed state, the end plate 5 is in the unloaded state. Furthermore, in the insertion step, even when the battery stack 2 is compressed in the stacking direction, in a case where the compressive force in the stacking direction does not act on the end plate-side end surface 8, the end plate 5 is in the unloaded state. That is, in the insertion step, as illustrated in FIG. 5, in a case where the end plate-side end surface 8 is separated from the case-side end surface 10, the end plate 5 is in the unloaded state. Similarly, in the insertion step, in a state where the compressive force in the stacking direction by the tool acts on the battery stacks 2, as illustrated in FIG. 6, even in a case where the end plate-side end surface 8 is in contact with the case-side end surface 10, the end plate 5 is in the unloaded state when the end plate-side end surface 8 is not pressed from the case-side end surface 10.

When the insertion step is completed, a step of extracting the insertion tool or the like is performed. By this step, when the insertion tool or the like is extracted, the state of the end plate 5 transitions from the unloaded state to a load application state. In a state where the battery stack 2 is accommodated in the accommodation space 9, the end plate-side end surface 8 and the case-side end surface 10 come into contact with each other, whereby the battery stack 2 is compressed in the stacking direction, and a restraint load is applied from the case 3 to the battery stack 2.

When the restraint load is applied from the case 3 to the battery stack 2, pressure is applied to a surface of the battery cell 6, and mutual movement of a plurality of the battery cells 6 and the separators 7 constituting the cell stack 4 is regulated and restrained. In order to obtain the restraint load, in the battery module 1, the end surfaces in the stacking direction of the battery stack 2 and the accommodation space 9 are inclined surfaces. With these inclined surfaces, the case-side end surface 10 functions as a restraint surface, and an appropriate restraint load can be applied to the cell stack 4.

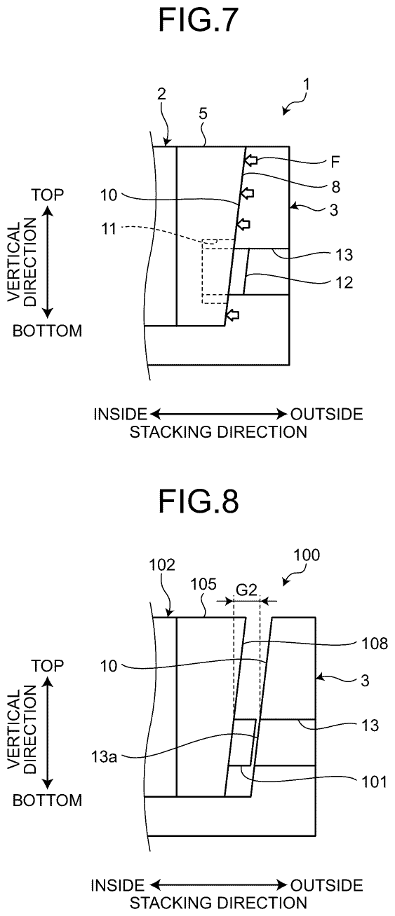

Specifically, after the battery stack 2 is inserted into the case 3, as illustrated in FIG. 7, a portion of the end plate-side end surface 8 that is in contact with the case-side end surface 10 receives a load F from the case-side end surface 10. The load F is a force acting inward in the stacking direction from the case-side end surface 10 to the end plate-side end surface 8. Therefore, the state illustrated in FIG. 7 is a state in which the end plate-side end surface 8 receives a compressive force (restraint load) in the stacking direction from the case-side end surface 10. In this case, the end plate 5 is in the load application state. As a result, the battery stack 2 is compressed in the stacking direction by the restraint load applied from the case-side end surface 10 to the end plate-side end surface 8.

In this load application state, a portion of the end plate-side end surface 8 in contact with the case-side end surface 10 receives the load F, and the battery stack 2 is compressed and deformed in the stacking direction. The battery stack 2 receives a restraint load of a magnitude obtained by multiplying a deformation amount by the spring constant. Then, pressure is uniformly applied to surfaces of the plurality of battery cells 6 included in the battery stack 2.

Moreover, in the load application state, the region 12 surrounded by the groove 11 in the end plate-side end surface 8 is not subjected to the load F. The region 12 surrounded by the groove 11 originally does not receive the load F and has a small deformation amount. A portion (contact surface) that receives the load F and a portion (region 12) that does not receive the load F are separated by the groove 11. With this structure, when the contact surface of the end plate-side end surface 8 of the end plate 5 receives the load F, the portion having the contact surface as the end surface is compressed and deformed inward in the stacking direction. On the other hand, the region 12 is less likely to be affected by a peripheral region receiving the load F even in the load application state due to the structure having the groove 11, and protrudes relatively outward in the stacking direction from the contact surface in the load application state.

As illustrated in FIG. 7, in the load application state in which the battery stack 2 is accommodated in the case 3, the contact surface of the end plate-side end surface 8 in contact with the case-side end surface 10 is pressed inward in the stacking direction from the case-side end surface 10, whereby the region 12 surrounded by the groove 11 relatively protrudes outward in the stacking direction from the contact surface and enters the inside of the hole 13. On the other hand, in the unloaded state, as illustrated in FIG. 6, the region 12 surrounded by the groove 11 does not relatively protrude and does not enter the inside of the hole 13.

The structure including the region 12 of the end plate 5 enters the inside of the hole 13 of the case 3, so that the catch structure functions. The hole 13 locks the structure including the region 12 and regulates upward movement of the battery stack 2. The structure including the region 12 surrounded by the groove 11 functions as a protrusion of the end plate 5. The hole 13 is used to catch the protrusion of the end plate 5 to regulate the movement of the battery stack 2 in the vertical direction. Since the case-side end surface 10 which is the restraint surface is the inclined surface, a force acts in a direction in which the battery stack 2 is shifted upward along the case-side end surface 10 together with the restraint load which is the compressive force in the stacking direction. Therefore, a catch is generated between the case 3 and the end plate 5, and the battery stack 2 is mechanically held. The catch structure is formed by the case 3 and the end plate 5, and the upward movement of the battery stack 2 can be regulated.

Furthermore, the insertion tool used in the insertion step can apply a compressive force in the stacking direction to the battery stack 2 without pressing the end plate-side end surface 8 in a state of being in contact with a portion of the battery stack 2 other than the end plate-side end surface 8. Therefore, in the end plate-side end surface 8, the region 12 surrounded by the groove 11 and the region not surrounded by the groove 11 are located on the same plane. That is, in the battery module 1 of the embodiment illustrated in FIG. 5, the gap G1 can be reduced.

In a case where an end plate 105 constituting a battery stack 102 has a protrusion 101 protruding outward in a stacking direction from an end plate-side end surface 108 as in a battery module 100 of a comparative example illustrated in FIG. 8, a gap G2 needs to be provided between the end plate-side end surface 108 and a case-side end surface 10 as a gap larger than or equal to a protruding amount of the protrusion 101. In this case, in order to provide the gap G2, it is necessary to increase a compression amount of the battery stack 102 in the insertion step.

On the other hand, in a battery module 1 according to the embodiment illustrated in FIG. 5, since the end plate-side end surface 8 including the contact surface and the region 12 is entirely flat on the same plane in the unloaded state in the insertion step (the region 12 surrounded by the groove 11 does not relatively protrude), the gap G1 between the case 3 and the battery stack 2 can be made smaller than the gap G2 in the case of adopting the battery module 100 of the comparative example.

As described above, according to the embodiment, only when a load is applied from the case 3 to the battery stack 2, the structure including the region 12 surrounded by the groove 11 in the end plate-side end surface 8 relatively protrudes outward in the stacking direction, and the catch structure functions. This makes it possible to suppress positional displacement of the battery stack 2 without impairing insertability when the battery stack 2 is inserted into the case 3.

Furthermore, the catch structure can be realized by a simple structure including the groove 11 provided in the end plate 5 and the hole 13 provided in the case 3.

Note that the hole 13 may have a shape depressed outward in the stacking direction with respect to the case-side end surface 10, and the depth thereof is not particularly limited. That is, the hole 13 may be a hole formed such that the bottom surface is a surface facing the region 12, or may be a through hole penetrating the case 3 along the stacking direction.

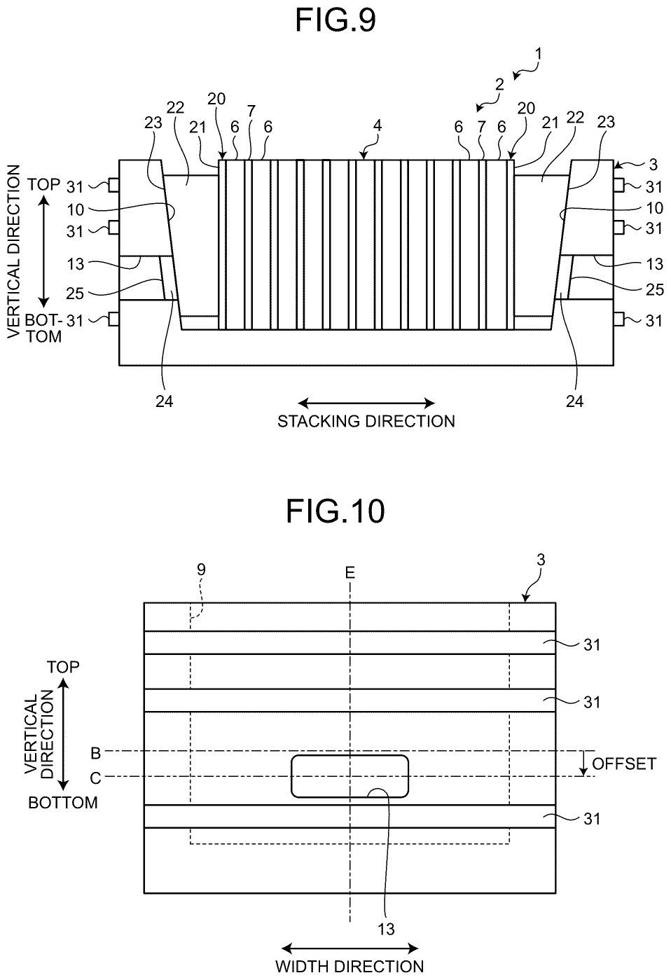

Furthermore, a battery module 1 according to a modified example will be described with reference to FIGS. 9 to 13.

As illustrated in FIG. 9, in the battery module 1 of the modified example, a battery stack 2 is formed of a stack including a cell stack 4 and a pair of end plates 20, and has a structure in which a rib 31 is provided on an outer wall of a case 3.

The case 3 has the linear rib 31 extending in a width direction on an outer surface of an outer wall portion provided outside in a stacking direction. As illustrated in FIG. 10, three ribs 31 are provided at different positions in a vertical direction. For example, on one outer wall portion of the case 3, two ribs 31 are provided at a position above a center position B in the vertical direction, and one rib 31 is provided at a position below the center position B in the vertical direction.

As illustrated in FIG. 10, a hole 13 has a rectangular shape with rounded corners. The hole 13 has a rectangular opening whose opening width in the width direction is longer than an opening width in the vertical direction. As described above, since the shape of the hole 13 is rectangular, it is possible to reduce a moment for rotating the battery stack 2.

The hole 13 is provided at a position C below the center position B in the vertical direction and at a center position E in the width direction. By providing the hole 13 at the center position E in the width direction of the case 3, it is possible to reduce a moment generated when the battery stack 2 receives an upward force and tries to move upward. Moreover, in a lower portion of the case 3, deformation of a case-side end surface 10 is smaller than that in an upper portion of the case 3 due to the effect that the member is provided on a bottom surface of the case 3. Therefore, a compressive force in the stacking direction tends to be strong in the lower portion of the case 3. Therefore, the end plate 5 is likely to protrude and catch. In short, it is suitable as a position where a catch structure is provided.

Furthermore, when the hole 13 is deep, it is difficult to manufacture the hole 13, and thus the hole 13 is disposed avoiding the ribs 31 provided for improving the rigidity of the case 3. In other words, the ribs 31 are not disposed at the position where the hole 13 is provided. In a case where it is assumed that the case 3 is an aluminum casting, it is assumed that the hole 13 is manufactured by a mold, and the hole 13 is formed by a through hole.

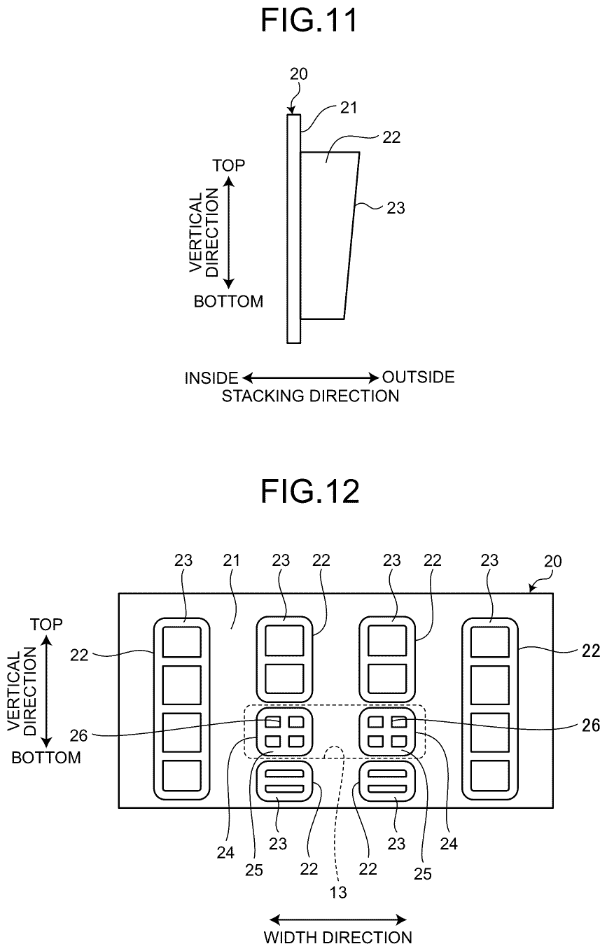

As illustrated in FIG. 11, an end plate 20 includes a base 21 having a flat plate shape, a rib 22 protruding outward in the stacking direction from the base 21, and an end plate-side end surface 23 which is an end surface on an outer side in the stacking direction of the rib 22.

Furthermore, as illustrated in FIG. 12, the end plate 20 includes a locking rib 24 formed at the position corresponding to the hole 13 of the case 3. The locking rib 24 is independent of the other ribs 22 and is like a small island. In the end plate 20, the rib 22 serves as a first rib, and the locking rib 24 serves as a second rib.

Furthermore, the end plate 20 has an end surface 25 on an outer side in the stacking direction of the locking rib 24. The locking rib 24 is surrounded by a depression toward the base 21 with respect to the end surface 25 on the outer side in the stacking direction. That is, the end surface 25 is a region surrounded by a recess depressed toward the base 21 with respect to the end surface 25.

Moreover, the end plate 20 is internally provided with a reinforcement rib 26 extending in the vertical direction so that a portion corresponding to the hole 13 of the case 3 resists a load in the vertical direction. That is, the locking rib 24 is a quadrangular rib extending linearly in the vertical direction and the width direction, and the reinforcement rib 26 extending linearly in the vertical direction is provided inside the locking rib 24.

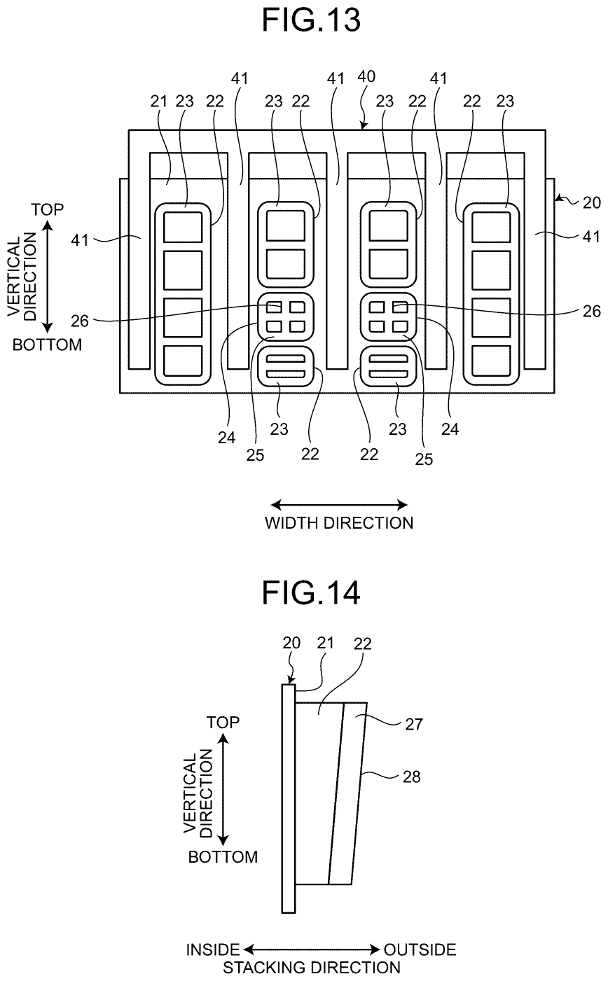

As illustrated in FIG. 13, the rib 22 serving as a contact surface with the case-side end surface 10 is provided so as to avoid a claw 41 of a machine-side tool 40 so that the battery stack 2 can be inserted while being compressed before being accommodated in the case 3.

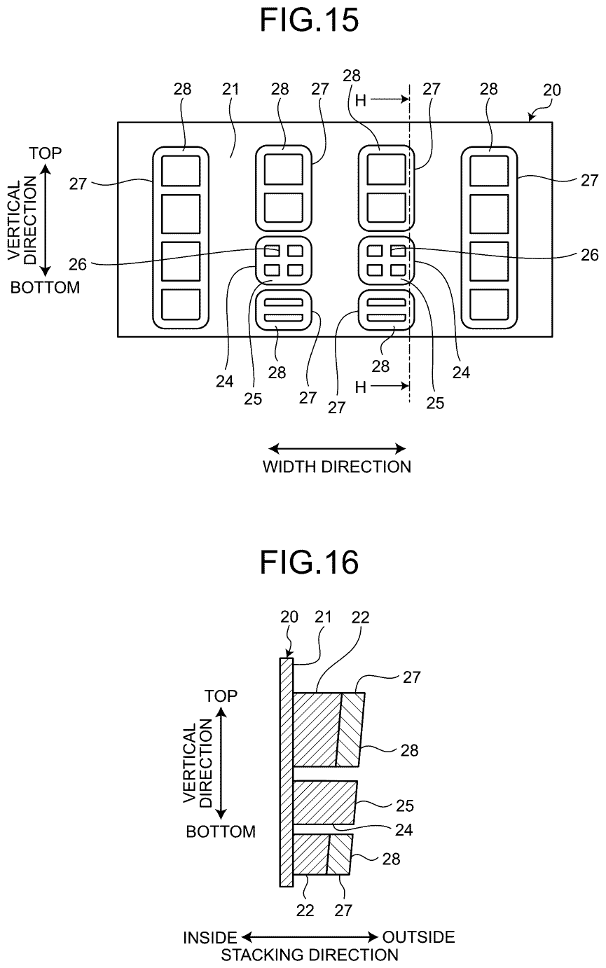

Furthermore, a battery module 1 according to a further modified example will be described with reference to FIGS. 14 to 16.

As illustrated in FIGS. 14 to 16, a battery module 1 according to the further modified example has a structure in which an elastic body 27 such as rubber is provided on an outer end surface of an end plate 20 in a stacking direction. The elastic body 27 is integrated with a tip portion of a rib 22 in the stacking direction. An end surface on an outer side in the stacking direction of the elastic body 27 forms an end plate-side end surface 28.

For the purpose of reducing a restraint load variation of a battery stack 2 with respect to a load variation factor, the elastic body 27 which is a member easily deformed is included in a part of the constituent members of the battery stack 2. Since the end plate-side end surface 28 is formed of the elastic body 27, a locking rib 24 can be further protruded, and a catch with a case 3 can be intensified. By providing the member on which the elastic body 27 is provided on a side of the end plate 20, the elastic body 27 can be made to have a minimum necessary amount. Furthermore, the number of parts can be reduced as compared with a structure in which a sheet-like elastic member is inserted between the end plate 20 and the case 3.

In the present disclosure, when the contact surface of the end plate-side end surface is pressed inward in the stacking direction from the case-side end surface, the region surrounded by the recess of the end plate-side end surface relatively protrudes outward from the contact surface and enters the inside of the hole of the case. Therefore, a catch structure can be formed by the case and the end plate. This makes it possible to suppress positional displacement of the battery stack without impairing insertability of the battery stack into the case.

According to an embodiment, when the contact surface of the end plate-side end surface is pressed inward in the stacking direction from the case-side end surface, the region surrounded by the recess of the end plate-side end surface relatively protrudes outward from the contact surface and enters the inside of the hole of the case. Therefore, a catch structure can be formed by the case and the end plate. This makes it possible to suppress positional displacement of the battery stack without impairing insertability of the battery stack into the case.

According to an embodiment, by providing the groove in the end plate-side end surface, it is possible to realize a catch structure in which the hole of the case locks a structure including the region surrounded by the groove.

According to an embodiment, it is possible to realize a catch structure in which the hole of the case locks the second rib of the end plate by the rib provided on the end plate.

According to an embodiment, when the second rib is locked to the hole, the reinforcement rib receives a load in the vertical direction, so that the second rib can withstand the load input in the vertical direction.

According to an embodiment, since the contact surface of the end plate-side end surface is formed of the elastic body, the elastic body is deformed, and the second rib can relatively protrude outward in the stacking direction.

According to an embodiment, in addition to the rectangular shape in which the hole is wide in the width direction of the case, since the hole is disposed at the center position in the width direction of the battery cell, it is possible to reduce a moment generated when the battery stack is about to move by receiving an upper force. Furthermore, since the hole is located below the center position in the vertical direction of the accommodation space, the deformation of the case-side end surface is reduced, so that a compressive force in the stacking direction tends to be strong. As a result, the end plate is likely to protrude, and mechanical catching with the case is likely to be obtained.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery module comprising:
a battery stack including a cell stack in which a plurality of battery cells are stacked in a thickness direction, and a pair of end plates disposed at both ends of the cell stack in a stacking direction; and
a case including an opening at an upper portion of the case, and an accommodation space in which the battery stack is accommodated,
wherein each of the end plates includes, as an outer end surface in the stacking direction, an end plate-side end surface inclined such that a dimension of the battery stack in the stacking direction decreases toward a lower end of the end plate,
the case includes, as an inner end surface in the stacking direction, a case-side end surface inclined such that a dimension of the accommodation space in the stacking direction decreases toward a lower end of the case,
the end plate-side end surface and the case-side end surface are brought into contact with each other to apply a restraint load in the stacking direction to the cell stack,
the end plate includes a recess formed so as to surround a part of the end plate-side end surface,
the case includes a hole formed at a position facing a region in the stacking direction, the region being surrounded by the recess of the end plate, and
in a state where the battery stack is accommodated in the case, a contact surface of the end plate-side end surface that is in contact with the case-side end surface is pressed inward in the stacking direction from the case-side end surface so that the region surrounded by the recess relatively protrudes outward in the stacking direction from the contact surface and enters an inside of the hole.

2. The battery module according to claim 1, wherein
the recess is a groove recessed inward in the stacking direction with respect to the contact surface,
the region surrounded by the groove includes an end surface inclined at a same angle as an inclination angle of the contact surface in an unloaded state where the contact surface is not pressed from the case-side end surface, and
the hole locks a structure including the region of the end plate surrounded by the groove, and regulates upward movement of the battery stack.

3. The battery module according to claim 1, wherein
each of the end plates includes:
a base having a flat plate shape and disposed on a plane orthogonal to the stacking direction; and
a rib protruding outward in the stacking direction from the base,
the rib includes:
a first rib whose outer end surface in the stacking direction is the contact surface; and
a second rib that is not pressed from the case-side end surface and is a structure in the region surrounded by the recess,
the recess is a depression toward the base in the stacking direction with respect to an outer end surface in the stacking direction of the second rib, and
the hole locks the second rib to regulate upward movement of the battery stack.

4. The battery module according to claim 3, wherein
the second rib includes a reinforcement rib that receives a load input from a vertical direction.

5. The battery module according to claim 4, wherein
the contact surface is formed of an elastic body integrated with the first rib.

6. The battery module according to claim 1, wherein
the hole is disposed below a center position in a vertical direction of the accommodation space and at a center position in a width direction of the battery cell, and includes a rectangular opening having an opening width in the width direction larger than an opening width in the vertical direction.
